(19) United States
(12) Patent Application Publication
(10) Pub. No.: US 2026/0290654 A1
(43) Pub. Date: Sep. 24, 2026

(54) WIRING MEMBER

(71) Applicant: SUMITOMO WIRING SYSTEMS, LTD., Yokkaichi-shi (JP)

(72) Inventors: Taiki SHIKATA, Yokkaichi-shi (JP); Hidetsugu KUBOTA, Yokkaichi-shi (JP); Hikaru NISHIO, Yokkaichi-shi (JP); Yukitoshi TERASAKA, Yokkaichi-shi (JP)

(73) Assignee: SUMITOMO WIRING SYSTEMS, LTD., Yokkaichi-shi (JP)

(21) Appl. No.: 19/571,839

(22) Filed: Mar. 19, 2026

(30) Foreign Application Priority Data
Mar. 20, 2025 (JP) 2025-046116

(51) Int. Cl. H01B 17/06; H02G 3/32

(52) U.S. Cl. CPC H01B 17/06; H02G 3/32

(57) ABSTRACT

Provided is a wiring member capable of suppressing circumferential displacement of a fixing member. A wiring member comprises: an electric wire; a grommet covering a circumference of the electric wire; and a fixing member configured to be attached to the grommet. The fixing member includes: a base end portion; and an attachment portion configured to be attached to an outer circumferential surface of the grommet. The outer circumferential surface of the grommet has a first contact surface formed in a direction intersecting a circumferential direction around an axis of the electric wire. The base end portion has a second contact surface configured to be in surface contact with the first contact surface.

### CROSS-REFERENCE TO RELATED APPLICATIONS

This application claims priority of Japanese Patent Application No. JP2025-046116 filed on Mar. 20, 2025, the contents of which are incorporated herein.

### TECHNICAL FIELD

The present disclosure relates to a wiring member.

### BACKGROUND

A grommet described in JP 2024-148841A includes: a tubular base member through which a wiring material such as an electric wire is inserted; and a grommet body coaxially assembled to the base member. The grommet body is made of an elastically deformable soft resin and has an annular shape.

JP 2024-148841A is an example of related art.

### SUMMARY

In the case of JP 2024-148841A, in a state in which a fixing member such as a clip is attached to the base member using a tie band or the like, the base member is in point contact with the seating surface (bottom surface) of the fixing member because the base member is tubular (i.e., cylindrical). There is thus a concern that the fixing member may be displaced relative to the grommet in the rotation direction (circumferential direction) around the axis of the wiring material. If the tie band is tightened strongly around the grommet in order to suppress displacement of the fixing member, the tie band may be damaged.

The present disclosure accordingly has an objective of providing a wiring member capable of suppressing circumferential displacement of a fixing member.

A wiring member according to the present disclosure includes: an electric wire; a grommet covering a circumference of the electric wire; and a fixing member configured to be attached to the grommet, wherein the fixing member includes: a base end portion; and an attachment portion configured to be arranged on an outer circumferential surface of the grommet along a circumferential direction, the outer circumferential surface of the grommet has a first contact surface formed in a direction intersecting a circumferential direction around an axis of the electric wire, and the base end portion has a second contact surface configured to be in surface contact with the first contact surface.

According to the present disclosure, it is possible to provide a wiring member capable of suppressing circumferential displacement of a fixing member.

### BRIEF DESCRIPTION OF THE DRAWINGS

FIG. 1 is a side view of a wiring member in Embodiment 1;

FIG. 2 is a transverse cross-sectional view of the wiring member in Embodiment 1;

FIG. 3 is a view corresponding to FIG. 2 in Embodiment 2;

FIG. 4 is a side view of a wiring member in Embodiment 3; and

FIG. 5 is a view corresponding to FIG. 2 in Embodiment 3.

### DETAILED DESCRIPTION OF PREFERRED EMBODIMENTS

First, embodiments of the present disclosure will be listed and described.
(1) A wiring member according to the present disclosure includes: an electric wire; a grommet covering a circumference of the electric wire; and a fixing member configured to be attached to the grommet, wherein the fixing member includes: a base end portion; and an attachment portion configured to be arranged along an outer circumferential surface of the grommet, the outer circumferential surface of the grommet has a first contact surface formed in a direction intersecting a circumferential direction around an axis of the electric wire, and the base end portion has a second contact surface configured to be in surface contact with the first contact surface.

With the above configuration (1), the first contact surface and the second contact surface are in surface contact with each other, so that displacement of the fixing member relative to the grommet in the circumferential direction can be suppressed. Since it is not necessary to strongly tighten the attachment portion around the grommet, fracture of the attachment portion can be prevented.
(2) Preferably, in the wiring member according to the above (1), the first contact surface and the second contact surface are planar.

With the above configuration (2), the contact area between the first contact surface and the second contact surface can be secured without complicating the structure of the wiring member.
(3) Preferably, in the wiring member according to the above (1) or (2), a protrusion configured to contact the attachment portion is provided on the outer circumferential surface of the grommet.

With the above configuration (3), the frictional resistance of the grommet against the fixing member in the circumferential direction can be increased, so that the attachment portion is less likely to be displaced relative to the outer circumferential surface of the grommet.
(4) Preferably, in the wiring member according to the above (3), a plurality of the protrusions are provided on the outer circumferential surface of the grommet, and the plurality of protrusions are arranged line-symmetrically with respect to an imaginary line passing through a center of the electric wire, with the first contact surface interposed therebetween, in a cross section obtained by cutting the wiring member in a direction orthogonal to an axial direction of the electric wire.

With the above configuration (4), circumferential displacement of the fixing member in both directions can be reliably suppressed.
(5) Preferably, in the wiring member according to any of the above (1) to (4), a recess into which a protrusion of the base end portion is configured to be fitted is provided on the outer circumferential surface of the grommet, and the first contact surface is a bottom surface of the recess.

With the above configuration (5), the fixing member can be positioned relative to the grommet in the circumferential direction.
(6) Preferably, in the wiring member according to any of the above (1) to (5), the grommet is a molded portion integrated with the electric wire.

With the above configuration (6), the electric wire and the grommet are integrated with each other, so that displacement of the grommet relative to the electric wire can be prevented.

Specific examples of embodiments of the present disclosure will be described below with reference to the drawings. The present disclosure is not limited to these examples, but is defined by the claims and intended to include all modifications within the meaning and scope equivalent to the claims.

### Embodiment 1

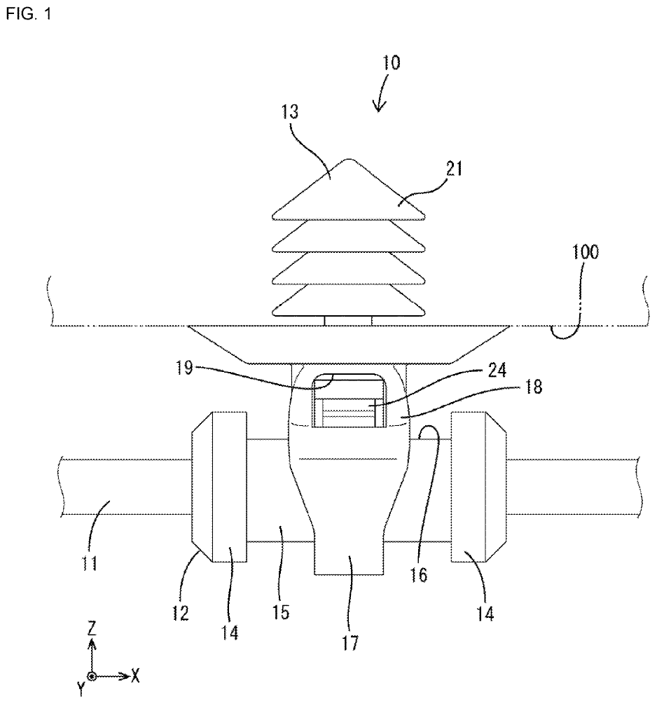

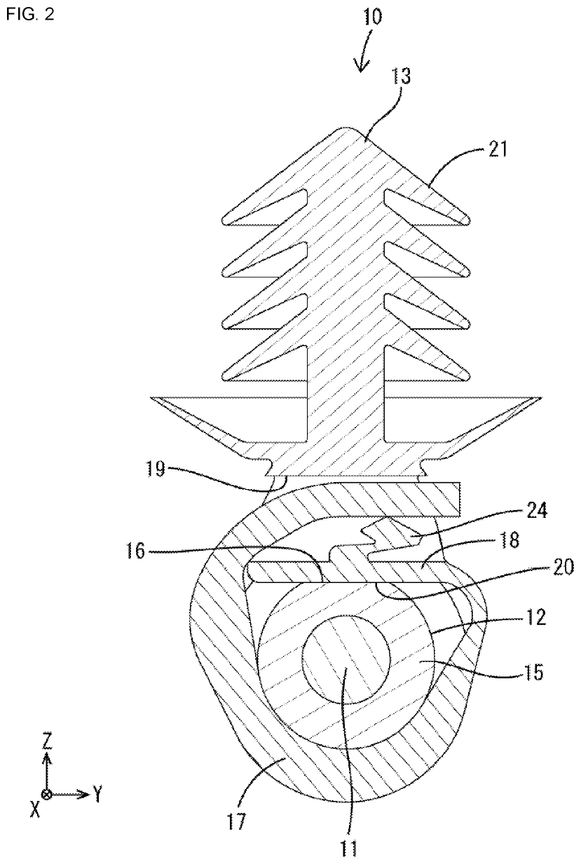

A wiring member 10 according to Embodiment 1 of the present disclosure includes: an electric wire 11; a grommet 12 covering the circumference of the electric wire 11; and a fixing member 13 attached to the grommet 12. The electric wire 11 is a covered electric wire in which a conductor formed of a core wire is covered with an insulating resin (the conductor and the insulating resin are not shown in the drawings). The insulating resin is a material such as vinyl chloride or an olefin-based resin. The wiring member 10 is attached to a vehicle body 100 of a vehicle (not shown in its entirety). In FIG. 1, X, Y, and Z represent forward, rightward, and upward directions, respectively. In the following description, for example, the left-right direction in FIG. 2 may also be referred to as a circumferential direction. These directional references are provided for convenience, and do not necessarily coincide with directional references in a state in which the wiring member 10 is mounted in a vehicle (not shown) or the like.

### Grommet 12

The grommet 12 is made of a thermoplastic elastomer such as vinyl chloride, polyolefin, or polyurethane, and is formed of a material capable of being integrated with the electric wire 11. As shown in FIGS. 1 and 2, the grommet 12 has a tubular shape. The grommet 12 is a molded portion integrated with the electric wire 11. While the shape of the grommet 12 is not particularly limited, in this embodiment, the grommet 12 includes a main body portion 15 extending in the axial direction and a pair of enlarged-diameter portions 14 protruding radially outward over the entire circumference from both axial ends of the main body portion 15.

As shown in FIG. 2, the main body portion 15 has a first contact surface 16 formed in a direction intersecting the circumferential direction around the axis of the electric wire 11. The first contact surface 16 is a surface facing upward in FIG. 2, and has a planar shape extending in a chord direction (i.e., a direction of a line segment connecting two points on the circumference, which corresponds to the left-right direction and the front-rear direction in FIG. 2). The first contact surface 16 is formed over the entire length of the main body portion 15 in the front-rear direction. The first contact surface 16 extends parallel to the axial direction of the electric wire 11. That is, the first contact surface 16 intersects each of the enlarged-diameter portions 14 perpendicularly.

The front-rear dimension of the first contact surface 16 is greater than the left-right dimension of the first contact surface 16. The left-right dimension of the first contact surface 16 is greater than the outer diameter of the electric wire 11.

As shown in FIG. 2, in a cross section obtained by cutting the wiring member 10 in a direction orthogonal to the axial direction of the electric wire 11 (i.e., the up-down direction and the left-right direction), the main body portion 15 has a non-circular shape due to the provision of the first contact surface 16. The outer circumferential shape of the main body portion 15 in cross section excluding the first contact surface 16 is a major arc shape. In a state in which the fixing member 13 is attached to the grommet 12, the first contact surface 16 is in surface contact with a second contact surface 20 of the fixing member 13 described below. The first contact surface 16 is not provided on the enlarged-diameter portions 14. The outer circumferential shape of each enlarged-diameter portion 14 in cross section is circular.

### Fixing Member 13

The fixing member 13 includes: a base end portion 18; and a band-shaped attachment portion 17 extending from the base end portion 18. A tie band can be used as the fixing member 13. A through hole 19 passes through the base end portion 18 in the left-right direction. The attachment portion 17 is insertable through the through hole 19. A locking portion 24 protrudes from the base end portion 18 into the through hole 19. The locking portion 24 is elastically deformable. As shown in FIGS. 1 and 2, in a state in which the fixing member 13 is attached to the grommet 12, the attachment portion 17 is wound around the outer circumferential surface of the main body portion 15 and is locked by the locking portion 24. The position at which the attachment portion 17 is locked by the locking portion 24 is variable, and the tightening strength of the attachment portion 17 around the main body portion 15 can be adjusted.

The base end portion 18 has a part that protrudes toward the inner circumference of the attachment portion 17 (i.e., protrudes downward). The base end portion 18 has the second contact surface 20 as the end surface in the protruding direction (i.e., bottom surface). The second contact surface 20 is located below the through hole 19. The second contact surface 20 has a planar shape extending in the front-rear direction and the left-right direction. The front-rear dimension of the second contact surface 20 is smaller than the left-right dimension of the second contact surface 20. The front-rear dimension of the second contact surface 20 is smaller than the front-rear dimension of the first contact surface 16. The left-right dimension of the second contact surface 20 is greater than the left-right dimension of the first contact surface 16. The left-right dimension of the second contact surface 20 is greater than the outer diameter of the main body portion 15. As shown in FIGS. 1 and 2, in a state in which the fixing member 13 is attached to the grommet 12, the second contact surface 20 is in surface contact with the first contact surface 16.

As shown in FIG. 1, a retaining portion 21 is provided on the base end portion 18 in a protruding manner. When the wiring member 10 is attached to the vehicle body 100, the retaining portion 21 is inserted into an attachment hole (not shown) of the vehicle body 100. The upward protruding part of the retaining portion 21 has a rib-like shape that protrudes in the front-rear direction and the left-right direction. The lower end part of the retaining portion 21 projects outward in the front-rear direction and the left-right direction.

### Functions of Wiring Member 10

An example of a procedure for manufacturing the wiring member 10 will be described. The electric wire 11 is set in a mold, and a thermoplastic elastomer is injected into the mold. As a result, the grommet 12, which is a molded portion integrated with the electric wire 11, is manufactured. Thus, the angular position of the grommet 12 relative to the electric wire 11 is reliably set. In addition, intrusion of water between the electric wire 11 and the grommet 12 can be prevented.

Following this, the fixing member 13 is attached to the grommet 12. While the second contact surface 20 of the fixing member 13 is in contact with the first contact surface 16 of the grommet 12, the attachment portion 17 is wound around the main body portion 15. The extension end of the attachment portion 17 is inserted into the through hole 19 of the base end portion 18 and the attachment portion 17 is locked by the locking portion 24, as a result of which the fixing member 13 is attached to the grommet 12. Since the first contact surface 16 and the second contact surface 20 are in surface contact with each other, displacement of the fixing member 13 relative to the grommet 12 in the circumferential direction can be suppressed even without strongly tightening the attachment portion 17 around the main body portion 15. Because the attachment portion 17 is not strongly tightened around the main body portion 15, fracture of the attachment portion 17 can be prevented. In addition, since both the first contact surface 16 and the second contact surface 20 are planar, the contact area between the first contact surface 16 and the second contact surface 20 can be secured without complicating the structure of the wiring member 10. Here, although the attachment portion 17 is not strongly tightened around the grommet 12, a tightening strength sufficient to fix the fixing member 13 to the grommet 12 is required.

### Embodiment 2

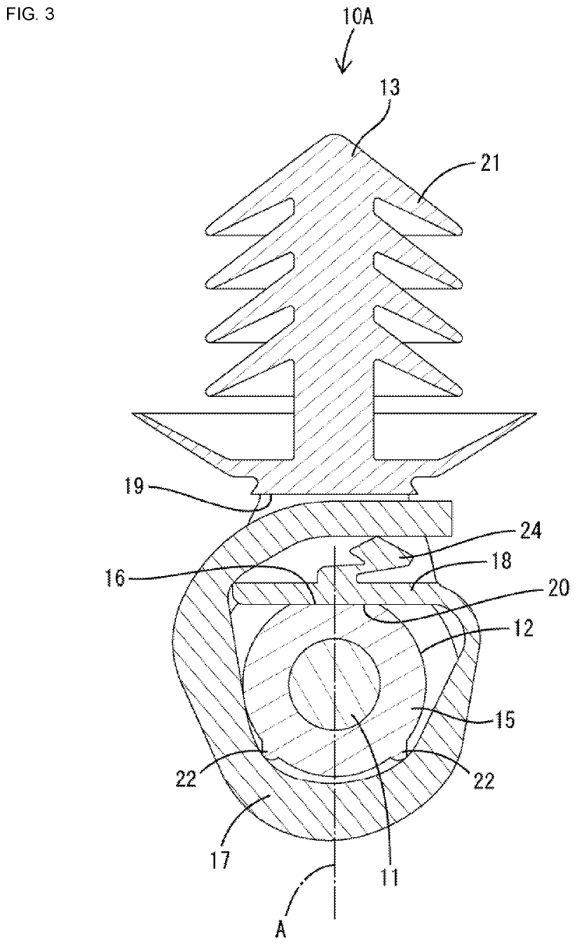

As shown in FIG. 3, a wiring member 10A according to Embodiment 2 of the present disclosure differs from Embodiment 1 in that a plurality of protrusions 22 protrude from the main body portion 15 of the grommet 12. Since Embodiment 2 is otherwise similar to Embodiment 1, components that are the same as or correspond to those in Embodiment 1 are given the same reference numerals and redundant description will be omitted. As shown in FIG. 3, two protrusions 22 are provided on the lower part of the main body portion 15. Each protrusion 22 extends in a rib-like shape over the entire length of the main body portion 15 in the front-rear direction. Each protrusion 22 protrudes radially outward from the outer circumferential surface of the main body portion 15. In a state in which the fixing member 13 is attached to the grommet 12, each protrusion 22 is in contact with the attachment portion 17. This increases the frictional resistance of the grommet 12 against the fixing member 13 in the circumferential direction. Hence, displacement of the fixing member 13 relative to the grommet 12 can be more effectively suppressed than in the case where no protrusion is provided on the grommet.

In a cross section obtained by cutting the wiring member 10 in a direction orthogonal to the axial direction, the protrusions 22 are arranged line-symmetrically with respect to an imaginary line A passing through the center of the electric wire 11, with the first contact surface 16 interposed therebetween. Thus, circumferential displacement of the fixing member 13 in both directions can be reliably suppressed.

### Embodiment 3

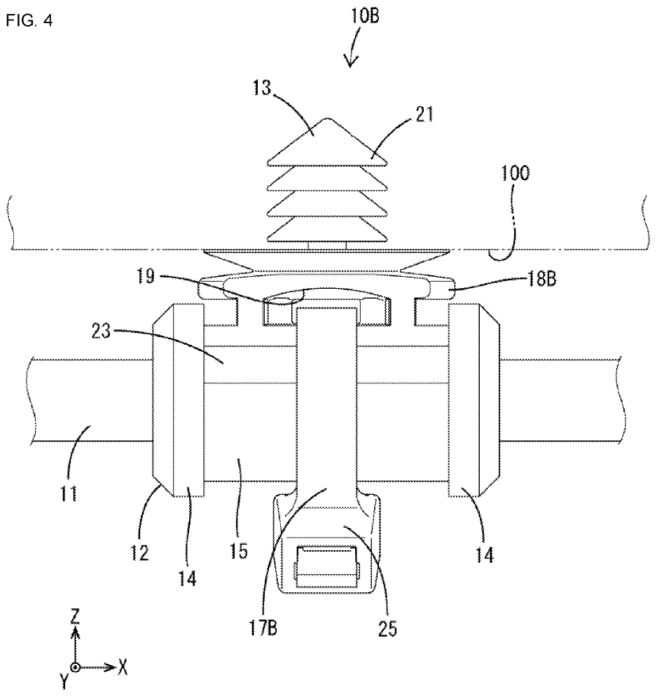

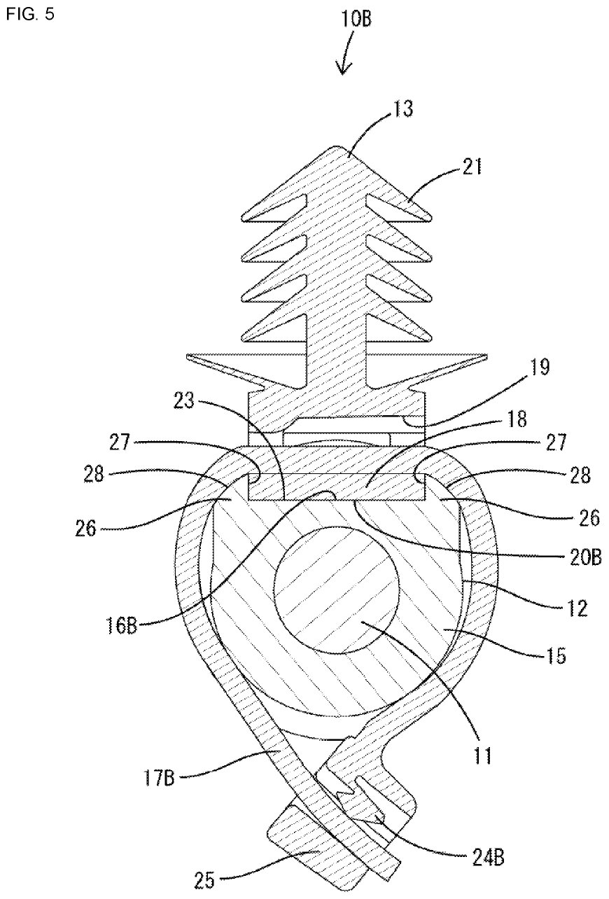

As shown in FIGS. 4 and 5, a wiring member 10B according to Embodiment 3 of the present disclosure differs from Embodiments 1 and 2 in that a recess 23 is provided in the main body portion 15 of the grommet 12 and a base end portion 18B and an attachment portion 17B are provided as separate members. Since Embodiment 3 is otherwise similar to Embodiment 1, components that are the same as or correspond to those in Embodiments 1 and 2 are given the same reference numerals and redundant description will be omitted.

As shown in FIG. 4, one end part of the attachment portion 17B is formed as an insertion portion 25 having a locking portion 24B inside. A hole passes through the insertion portion 25 in the left-right direction, and the locking portion 24B protrudes into the hole. The other end part of the attachment portion 17B is inserted into the insertion portion 25, and the attachment portion 17B is locked by the locking portion 24B. The attachment portion 17B is thus tightened around the main body portion 15.

The main body portion 15 has a pair of projections 26 that protrude upward from the outer circumferential surface of the upper part of the main body portion 15. The projections 26 have respective inner surfaces 27 facing each other in the left-right direction. The inner surface 27 of each projection 26 extends in the up-down direction. The inner surfaces 27 of the projections 26 close both ends of the recess 23 in the left-right direction, and also serve as the left and right side surfaces of the recess 23. Each projection 26 has an outer surface 28 that continuously extends in an arc shape (outer circumferential shape in transverse cross section) between the outer circumferential surface of the upper part of the main body portion 15 and the inner surface 27. The outer surface 28 of each projection 26 can be in contact with the inner circumferential surface of the attachment portion 17B. A protrusion of the base end portion 18B is fitted into the recess 23. The recess 23 is formed over the entire length of the main body portion 15 in the front-rear direction. The bottom surface of the recess 23 is a first contact surface 16B and has a planar shape.

As shown in FIG. 5, the left-right dimension of the first contact surface 16B is greater than the outer diameter of the electric wire 11. The left-right dimension of the first contact surface 16B and the left-right dimension of a second contact surface 20B of the fixing member 13 are substantially equal to each other. The first contact surface 16B and the second contact surface 20B are in surface contact with each other. The first contact surface 16B and the second contact surface 20B are in contact with each other over the entire length in the left-right direction. The inner surfaces 27 of the projections 26 are arranged so as to be capable of being in surface contact with the left and right side surfaces of the base end portion 18B. Accordingly, the fixing member 13 can be positioned relative to the grommet 12 in the circumferential direction. In particular, as a result of the outer surfaces 28 of the projections 26 being in contact with the attachment portion 17B, the state in which the attachment portion 17B is tightened around the main body portion 15 can be stabilized.

### Other Embodiments of the Present Disclosure

The embodiments disclosed herein should be considered to be illustrative in all respects and not restrictive.

In Embodiments 1 to 3, the cross section of the grommet 12 has a non-circular shape due to formation of the first contact surface 16, 16B. In other embodiments, the cross section of the grommet may have a non-circular shape different from those in Embodiments 1 and 2. For example, the cross section may have a polygonal shape.

In Embodiments 1 to 3, the first contact surface 16, 16B and the second contact surface 20, 20B have planar shapes. In other embodiments, the first contact surface and the second contact surface are not necessarily planar, as long as they each have a part extending in a direction intersecting the circumferential direction of the electric wire. For example, the first contact surface and the second contact surface may be uneven surfaces.

In Embodiment 2, the plurality of protrusions 22 are provided on the outer circumferential surface of the main body portion 15 of the grommet 12. In other embodiments, instead of providing protrusions, the surface of the grommet may be matte-finished.

In Embodiment 2, the plurality of protrusions 22 are arranged line-symmetrically with respect to the imaginary line A. Alternatively, the plurality of protrusions may be arranged not symmetrically with each other.

In Embodiments 1 to 3, the grommet 12 is a molded portion formed integrally with the electric wire 11. In other embodiments, the grommet and the electric wire may be separate members and not integral with each other.

What is claimed is:

1. A wiring member comprising:
an electric wire;
a grommet covering a circumference of the electric wire; and
a fixing member configured to be attached to the grommet,
wherein the fixing member includes: a base end portion; and an attachment portion configured to be arranged on an outer circumferential surface of the grommet along a circumferential direction,
the outer circumferential surface of the grommet has a first contact surface formed in a direction intersecting a circumferential direction around an axis of the electric wire, and
the base end portion has a second contact surface configured to be in surface contact with the first contact surface.

2. The wiring member according to claim 1, wherein the first contact surface and the second contact surface are planar.

3. The wiring member according to claim 1, wherein a protrusion configured to contact the attachment portion is provided on the outer circumferential surface of the grommet.

4. The wiring member according to claim 3, wherein a plurality of the protrusions are provided on the outer circumferential surface of the grommet, and
the plurality of protrusions are arranged line-symmetrically with respect to an imaginary line passing through a center of the electric wire, with the first contact surface interposed therebetween, in a cross section obtained by cutting the wiring member in a direction orthogonal to an axial direction of the electric wire.

5. The wiring member according to claim 1, wherein a recess into which a protrusion of the base end portion is configured to be fitted is provided on the outer circumferential surface of the grommet, and
the first contact surface is a bottom surface of the recess.

6. The wiring member according to claim 1, wherein the grommet is a molded portion integrated with the electric wire.
